(19) United States
(12) Patent Application Publication
(10) Pub. No.: US 2023/0410206 A1
(43) Pub. Date: Dec. 21, 2023

(54) SYSTEM AND METHOD FOR DETERMINING A BONUS PAYMENT FOR A RETIREMENT INCOME PLAN

(71) Applicant: Paceit, Inc., Santa Monica, CA (US)

(72) Inventors: Shlomo BENARTZI, Santa Monica, CA (US); Ehud PELEG, Los Angeles, CA (US)

(21) Appl. No.: 18/206,739

(22) Filed: Jun. 7, 2023

Related U.S. Application Data
(60) Provisional application No. 63/352,784, filed on Jun. 16, 2022.

(51) Int. Cl. G06Q 40/06; G06Q 40/02

(52) U.S. Cl. CPC G06Q 40/06; G06Q 40/02

(57) ABSTRACT

A computer-implemented method for generation of a periodic bonus payment amount for a user that has a personalized income plan, comprising the steps of obtaining, by a processor, information about a paycheck spending plan for the user, including information about a current real amount of the paycheck, a user's investment portfolio, including an actual return on the investment portfolio and an expected return on the investment portfolio, storing the paycheck spending plan information in a computer memory; determining, by a processor, a two bonus payment options, based at least in part on the current real amount of the paycheck, the actual return on the investment portfolio and the expected return on the investment portfolio, wherein the bonus payment amount is determined to be the greater of the two options; providing to a user, via a user interface, information about the bonus payment.

### CROSS REFERENCE TO RELATED APPLICATIONS

This application claims priority to U.S. Provisional Patent Application Ser. No. 63/352,784 titled “System And Method For Determining A Bonus Payment For A Retirement Income Plan”, filed Jun. 16, 2022, the disclosure of which is incorporated by reference herein in its entirety.

### FIELD

This disclosure relates generally to the field of personalized financial planning for retirement. More specifically, it relates to a system and method for determining an amount of a periodic bonus payment for a retiree that has a retirement income plan that provides the user with payments designed to provide the retiree with income for the user's lifetime. The bonus payment and other payments are made from funds drawn from a user's retirement savings.

### BACKGROUND

Despite the fact that people today generally live longer and save less, many people seek to retire as early as possible. People seeking to retire are concerned that they will run out of money in retirement and outlive their savings. Individuals may seek personalized income plans that provide certainty for retirement income for the life of the retiree.

A financial service provider may offer to create and implement a retirement income plan (sometimes also referred to herein as a retirement payment plan, a retirement spending plan or a paycheck plan) for retirees in which the financial service provider provides the retiree a monthly payment from the retiree's retirement savings. Systems and methods are available to the financial service provider for creating such retirement payment plans, including personalized payment plans that take into account a person's longevity and savings, the retiree's income from social security, and other factors, and endeavor to provide a payment plan that is designed to last for the life of the retiree. The payments are sometimes referred to herein as “paychecks”. There may be one or more savings or retirement accounts of the retiree that may be considered in determining the plan and from which paychecks can be disbursed. Those accounts may be referred to herein, collectively, as the retiree's “savings account”.

The amount of the paycheck may be computed under the assumption that there is a probability that the savings account will run out before the retiree dies (or the retiree and their spouse in case of a joint account.) Some systems and methods may allow a retiree to adjust their risk of running out of money by adjusting the probability. The amount of risk taken also affects the size of the paycheck. Taking higher risk implies a larger paycheck.

A periodic bonus may be desired and appropriate when, for example, the retiree's savings account is invested, in whole or in part, in assets having a market value, such as stocks or an investment portfolio, and has seen positive results for successive years as captured by a higher balance in the savings account. The amount of the bonus payment may be based on the current balance of the savings account. Computing the bonus based on the balance of the savings account only as a result of positive investment returns has disadvantages that might cause disappointment to participants in the future. For example, making the determination of the bonus payment on this basis alone may lead to long periods of no bonus if the investment portfolio underperforms over a period of time. Making the determination by this method alone also may not be responsive to a period of good performance of the investment portfolio.

The present system and method described herein provide for a bonus payment determination to be made based on several factors and by comparing possible bonus payment amounts, to determine a bonus payment that will not change the amount of the calculated amount of the paycheck payment to be provided to the retiree. The system and method described herein provide advantages to retirees that participate in retirement income plans by, for example, providing a bonus payment without impacting the sustainability of the paycheck for the life of the retiree. The system and method described herein also provide advantages to retirement plan savings provider by, for example, by offering a plan that has an option for the retiree to receive a bonus which will make the plan more attractive to the retiree and keep the retiree happy and engaged with the plan.

### SUMMARY

One aspect of the invention includes a system and computer-implemented method for generation of bonus payment amount to be given to a retiree participating in a retirement income plan. The system and computer-implemented method includes the steps of receiving information about an individual's retirement income plan and then, based on that information, determining a bonus payment based on a determination of several factors and comparing different possible bonus payment amount options.

Other advantages of the present invention will become readily apparent from the following detailed description. The invention is capable of other and different embodiments, and its several details are capable of modifications in various obvious respects, all without departing from the invention. Accordingly, the drawing and description are illustrative in nature, not restrictive.

### BRIEF DESCRIPTION OF THE DRAWINGS

The foregoing aspects and many of the attendant advantages of the disclosed embodiments will become more readily appreciated by reference to the following detailed description, when taken in conjunction with the accompanying drawings, wherein:

FIG. 1 illustrates a block diagram of an example of a computing environment for determining a bonus payment that provides the user with a bonus payment.

FIG. 2 is a flow diagrams illustrating operation of one example of the method implemented by the system.

FIG. 3 is a flow diagrams illustrating a glidepath of one example of the method implemented by the system.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details.

An ongoing area of interest in the retirement planning area is how to better customize retirement income plans for individuals. Individuals seek personalized plans that are easy to develop and provide certainty. One example is for retirement savings plan providers who desire to offer every plan participant options for developing such plans and hope to retain the participant's investment account as they draw down on the account during retirement. If the plan provider can offer a personalized income plan where income is distributed to the individual periodically from the retirement account, the financial services provider may be able to retain retirement funds for a longer period of time and may be able to charge fees for helping develop the plan and/or sending distribution or income payments to the retiree. The financial services company may wish to offer as an option a periodic bonus payment to the retiree provided the retiree's income plan is not adversely impacted by such a bonus payment. Systems and methods disclosed herein provide a bonus payment amount that allows the retiree to receive a bonus payment, while still having confidence their retirement income plan will not be adversely impacted.

Generally, an example of a system and method that a financial services company may use to develop a retirement income plan is described in U.S. patent application Ser. No. 18/081,406, the description of which is incorporated by reference. As described, therein, the paycheck for a retiree may be personalized based on, among other things, the user's selection of the amount of risk the user is willing to take in terms of outliving their savings.

Such a system can provide a spending plan based on certain information about the value of the retiree's savings account at the time the plan is developed. The savings account balance will change over time due to drawdowns, i.e., paychecks paid to the retiree, and due to market performance of any investment accounts that make up the savings account.

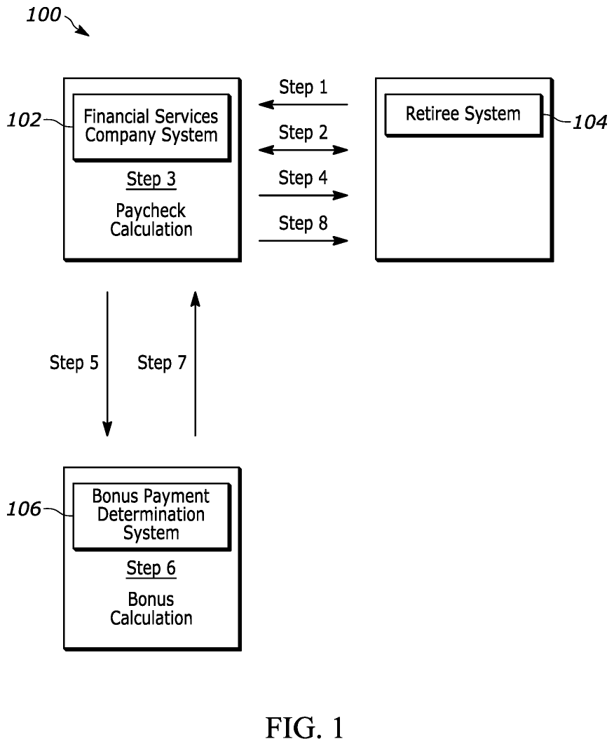

The discussion will now turn to FIG. 1, which is a block diagram illustrating an example of a computing environment 100 for creating a personalized retirement income plan that also includes a bonus payment. Generally, the environment 100 includes a financial services company system 102 (sometimes referred to herein as a spending plan system or income personalization system), a user or retiree computing system or device 104 and a bonus determination system 106.

The financial services company system 102 may generate and administer a retirement income plan for a retiree, such as a personalized retirement income plan that offers a bonus payment option. The spending plan system 102 may have various components, such as a background information component, an introduction component, a personalization component and a financial engine component, that are used to generate the spending plan. While the income personalization system 102 and bonus determination system 106 are illustrated in FIG. 1 as separate systems, it may be understood that functionalities of one or more of the systems or components thereof also may be performed by a computing device or by a distributed computing environment including a plurality of computing devices, without limit. Similarly, the bonus determination system 106 may be part of the financial services company's system 102 or may be a third-party system.

Generally, as an initial step (Step 1), the retiree system 104 may send a request for a retirement income plan (“paycheck plan”) to the financial services company system 102.

Next, in Step 2, the financial services company system 102 may request information from retiree or retiree system 104 to determine a sustainable paycheck plan. The information requested from the retiree system 104 may include:
Retiree's age
Retiree's assets to be considered
Health status
Personalization
Other information

Next, in Step 3, the financial services company system 102 may determine a paycheck plan based on information provided, e.g., the system 102 calculates periodic payments to be made to the retiree from assets such that the probability of outliving those assets is minimized to a pre-set level. These periodic payments are herein referred to as “paychecks”. These payments or paychecks may include an amount that comes from the retiree's savings account, as well as an amount that comes from the retiree's Social Security payments. The portion of the paycheck that comes from the savings account is herein referred to herein as “the current real amount”. Note that the current real amount portion of the paycheck may be adjusted over time.

The calculation of the current real amount portion of the paycheck may be based on the value of the savings account. If all or a portion of the savings account is invested in an investment portfolio, the system 102 may, for example, calculate the paycheck using an expected rate of return and the standard deviation for the investment portfolio. As an alternative to determining the paycheck plan itself, the financial services company may request a third party to develop the paycheck plan based on the collected information and information from the financial services company. The paychecks may then be paid to the retiree per a schedule, e.g., monthly.

Next, in Step 4, the financial services company system 102 provides information to the retiree about the paycheck plan, e.g., the plan for the periodic payments they will receive. The financial services company 102 may also begin making the paycheck payments to the retiree.

At the end of the year, the financial services company may compute any inflation adjustment that will be applied to the following year's paycheck from the retirement account. The adjustment may be made to the current real amount portion of the paycheck based on the Social Security cost of living adjustment (“COLA”) for the year. The adjustment may also be based on or computed by any other method determined by the financial services company. The retiree's paycheck may also include an adjustment to the social security portion based on adjustments to be made by social security as well.

Next, in Step 5, at the end of the year, the financial services company system 102 also provides information to a bonus determination system 106 to allow the system 106 to determine whether a bonus payment can be made, and if so, the amount of the bonus payment. Generally, the bonus payment, which may be an additional annual payment, is meant to capture upward potential that exists when the retiree's underlying investment portfolio has been successful. Of course, a bonus payment need not be determined and paid annually, and may be made at different times, for example, bi-annually or semi-yearly or at any time requested by the user.

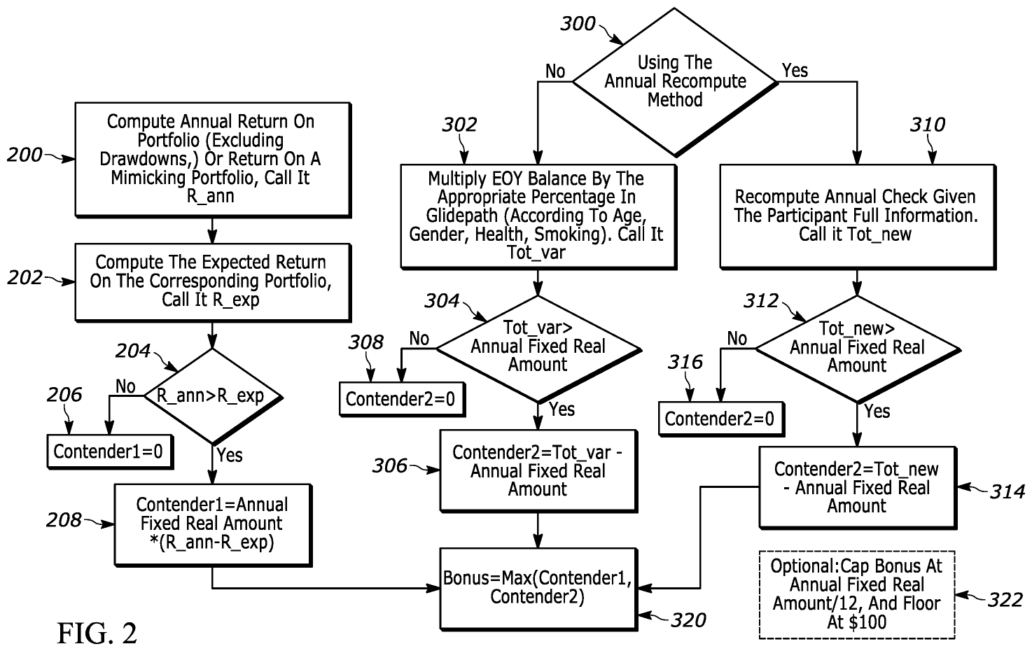

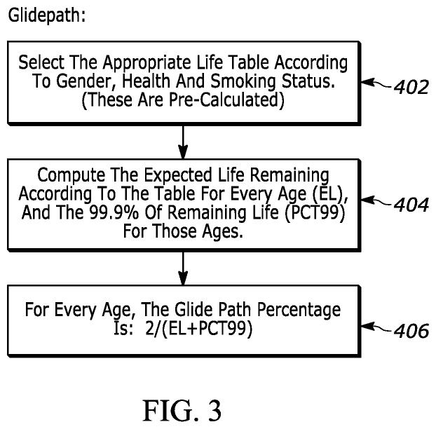

Next, in Step 6, the bonus determination system 106 determines whether a bonus payment can be made, and if so, the amount of the bonus payment. A more detailed discussion of how the system 106 determines the amount of the bonus payment is provided below with respect to FIGS. 2 and 3.

Next, in Step 7, the bonus determination system 106 provides bonus payment information, e.g., the amount of the bonus to be paid to the retiree and the date the payment is to be made, to the financial services company system 102.

Next, in Step 8, the financial services company system 102 provides bonus payment information to the retiree system 104 to inform the retiree the amount of the bonus to be paid. Other bonus payment information may be provided such as when the payment will be made and how it will be made. The financial services company 102 may also make the bonus payment to the retiree based on the bonus payment information provided from the bonus determination system 106. Receipt of the bonus payment information at the financial services company system 102 may cause the financial services company system 102 to generate a financial transaction, such as a payment to the retiree by check, wire payment or ACH payment, in the amount of the bonus from a retiree savings account at the financial services company. The bonus payment may be automatically generated on a predetermined or desired date, e.g., a predetermined annual or semi-annual date or a date specified by the retiree, or date designated by the bonus payment system 106. The bonus payment may made be from a retiree's savings account at the financial services company or at another financial institution. If the bonus payment is to be made from another financial institution, the financial services company 102 send an instruction to that institution to make the bonus payment and provide that institution with bonus payment information. An alert may also be sent to the retiree system 104 from the financial services company system 102 to alert the retiree that a payment has been made or will be made and to inform the retiree of the amount of the payment, and how and when the bonus payment was or will be made and what account it will be paid from. The alert can be formatted to be displayed on a user interface at the user system 104. Utilizing a bonus determination system as described herein to automate the determination of the amount of the bonus payment and automating the alerts and information to be provided to the financial services company, retiree and/or other financial institution, as well as automating the payment of the bonus payment, provide several benefits, including providing confidence that a retiree's personalized retirement income plan is sustainable, while still providing extra income to the retiree. They also provide the benefit of being a more efficient and seamless process for the user and financial services company.

FIG. 2 is a flow diagram illustrating operation of one example of a method that may be implemented by the bonus determination system 106 to determine whether a bonus payment can be made, and if so, the amount of the bonus payment. Generally, and as described in more detail below, two or more bonus payment amount options or contenders are determined and then compared. The bonus to be paid may be the larger of the bonus payment amount options. Also, as described below in more detail, the bonus payment amount may be set to a minimum or maximum amount under certain conditions.

Turning now to FIG. 2, at Step 200, the system 106 may determine a first bonus payment amount option by computing the annual return of the portfolio in the savings account. The amount of the return may be determined, excluding any drawdowns for the year. The amount of the annual return is referred to herein as “R_ann”.

In a next Step, 202, the system 106 may compute or determine the expected return on the portfolio in the savings account. The amount of the expected return is referred to herein as “R_exp”. The amount of the expected return may be determined, for example, to be the expected return rate used by the financial services system 102 to determine the amount of the paychecks.

Next, in Step 204, the system 106 may compare the annual return (R_ann) to the expected return (R_exp). If the annual return (R_ann) is not greater than the expected return (R_exp), then the system 106 may set the amount of the first bonus payment option or first contender to zero (Step 206).

On the other hand, if the annual return (R_ann) is greater than the expected return (R_exp), then in Step 208, the system 106 may set the amount of the first bonus payment option to the annual current real amount of the paycheck times the difference between the annual return (R_ann) and the expected return (R_exp), i.e., bonus payment option 1=Annual Current Real Amount*(“R_ann”−“R_exp”).

As shown beginning in Step 300, the system 106 may determine a second bonus payment amount option or contender. The system 106 may determine that second bonus payment option by one of two alternate methods: a glidepath method (starting at Step 302) or an annual recompute method (starting at Step 310).

If using the glidepath method, the system 106 may compute a drawdown amount (Tot_Var) based on a percentage multiplied by the balance of the savings account at the end of the year or at any desired period of time.

Referring now to FIG. 3, the system 106 may determine the percentage used to compute the drawdown amount from an upward-sloping glide path that is based on age, gender, health and smoking status (Step 402) used by the financial services system 102 to determine the amount of the paycheck. To compute the glide path (i.e., percentage for every age), the system 106 may take the expected remaining life of the retiree and the 99.9 percentile of remaining life for the retiree (Step 404) and also may take “Required Minimum Distribution” requirements into account as per IRS regulations for certain retirement accounts. These may be taken from life tables commonly used in the industry, after adjusting for the parameters mentioned. The percentage is then calculated to be the inverse of the average of the expected remaining life and the 99.9 percentile of remaining life. (Step 406).

Referring back to FIG. 2, the system 106 may compare the drawdown amount (Tot_Var) to the annual current real amount of the paycheck (i.e., portion of the paycheck that does not include social security) (Step 304). If the drawdown amount (Tot_Var) is greater than the annual current real amount of the paycheck, then the system 106 may set the second bonus amount option to the difference between them (Step 306). On the other hand, if the drawdown amount is less than the annual current real amount of the paycheck, then the system 106 may set the second bonus amount option to zero (Step 308).

Alternatively, the system 106 may determine a second bonus amount option by a “recompute” method, beginning at Step 310. In this method, the financial services company system 102 may re-run its engine to determine a new current real amount of the paycheck based on present circumstances (Tot_New). The system 106 may then compare the annual total of the new current real amount of the paycheck to the current adjusted annual current real amount (not including social security) (Step 312).

If the annual total of the new current real amount of the paycheck is greater than the current adjusted real current real amount (not including social security), then the system 106 may set the second bonus amount option to the difference between them (Step 314). If it is not greater, then the system 106 may set the second bonus amount option to zero (Step 316).

After the first bonus amount option and the second bonus amount option are determined, the system 106 may compare them (Step 320) and set the actual bonus amount to the larger of the two amounts.

Optionally, the system 106 may also compare the actual bonus amount to a minimum or maximum bonus amount (Step 322). If the actual bonus amount is less than the minimum, the system 106 may set the actual bonus amount to the minimum amount. Similarly, if the actual bonus amount is greater than the maximum, the system 106 may set the actual bonus amount to the maximum amount. For example, the minimum may be set at $100 and the maximum may be set at 1/12 of the annual current real amount. But other minimums and maximums may be used.

The above examples generally contemplate a bonus payment determined by the system 106 annually at the end of the year. However, the bonus payment determination may take place at any time and in any frequency.

The systems and devices, and other devices such as other computing devices and/or storage devices containing information used by the systems and devices, are in communication over one or more networks. Embodiments of the financial services company system 102, the user or retiree computing system or device 104, and the bonus payment determination system 106, may be independently selected by any computing device such as desktop computers, laptop computers, mobile phones, tablet computers, server computers, client computers, and the like or by a distributed computing environment including a plurality of computing devices, without limit. Embodiments of data storage devices (not shown) may include one or more data storage devices capable of maintaining computer-readable data. Examples may include, but are not limited to, magnetic storage (e.g., hard disk drives, etc.), solid state storage (e.g., flash memory, etc.), network storage, and other computer-readable media known in the art. Embodiments of the network may include, but are not limited to, local area networks (LANs), wide area networks (WAN), the Internet, wired networks, wireless networks, and telephone networks.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The invention claimed is:

1. A computer-implemented method for generation of a bonus payment amount for a user that has a personalized income plan, comprising the steps of:
obtaining, by a processor, information about a paycheck spending plan for the user, including information about a current real amount of the paycheck, a user's investment portfolio, including an actual return on the investment portfolio and an expected return on the investment portfolio,
storing the paycheck spending plan information in a computer memory;
determining, by a processor, two bonus payment options, based at least in part on the current real amount of the paycheck, the actual return on the investment portfolio (“R_ann”) and an expected return on the investment portfolio (“R_exp”); wherein the bonus payment amount is determined to be the greater of the two options;
providing to a user, viewable by a user interface, information about the bonus payment amount.

2. The method of claim 1 wherein the processor determines a first bonus payment option by:
determining an annual return of the investment portfolio (“R_ann”);
determining an expected return on the investment portfolio (“R_exp”);
comparing the annual return (“R_ann”) to the expected return (“R_exp”);
setting the amount of the first bonus payment option to zero if the annual return (“R_ann”) is not greater than the expected return (“R_exp”); and,
setting the amount of the first bonus payment option to the annual current real amount of the paycheck times the difference between the annual return (“R_ann”) and the expected return (“R_exp”), if the annual return (“R_ann”) is greater than the expected return (“R_exp”).

3. The method of claim 2 wherein the processor sets the amount of the expected return (“R_exp”) at the expected return rate used by the financial services system to determine the amount of the annual current amount of the paycheck.

4. The method of claim 2 wherein the processor determines a second bonus payment option by:
computing a drawdown amount (“Tot_Var”) based on a percentage multiplied by the balance of the savings account on a predetermined date;
wherein the percentage is determined from an upward-sloping glide path that is the inverse of the average of the expected remaining life and the 99.9 percentile of remaining life;
setting the second bonus amount option to the difference between the drawdown amount (Tot_Var) and the annual current real amount of the paycheck, if the amount is greater than zero; otherwise setting the second bonus amount option to zero.

5. The method of claim 2 wherein the processor determines a second bonus payment option by:
determining a new current real amount of the paycheck based on present circumstances (Tot_New);
comparing the annual total of the new current real amount of the paycheck to the annual total of the current real amount;
if the annual total of the new current real amount of the paycheck is greater than the current adjusted real current real amount, then setting the second bonus amount option to the difference between the new current real amount of the paycheck and the real amount; otherwise setting the second bonus amount option to zero.

6. The method of claim 1 wherein the processor that determines the bonus payment options compares the bonus payment amount to a minimum bonus amount and if the bonus payment amount is less than the minimum bonus amount, the system revises the bonus payment amount to set it at the minimum bonus amount before sending information about the bonus payment amount to the user.

7. The method of claim 1 wherein the processor that determines bonus payment options the compares the bonus payment amount to a maximum bonus amount and if the bonus payment amount is greater than the maximum bonus amount, the system revises the bonus payment amount to set it at the maximum bonus amount before sending information about the bonus payment amount to the user.

8. The method of claim 1 wherein the information provided to a user, viewable by a user interface, about the bonus payment amount, includes one or more of: the bonus payment amount, a bonus payment date, a bonus payment minimum and a bonus payment maximum.

9. A system for creating a generation of a bonus payment amount for a user that has a personalized income plan, comprising:
a plurality of first data storage devices maintaining information about a current real amount of the paycheck, a user's investment portfolio, including an actual return on the investment portfolio and an expected return on the investment portfolio;
a bonus determination device in communication with the storage devices, configured to determine two bonus payment options based at least in part on the current real amount of the paycheck, the actual return on the investment portfolio and the expected return on the investment portfolio, then comparing the bonus payment options to determine the greater of the two options and setting the bonus payment amount at the greater of the options; and
configured to send information to a financial services company system with information about the amount or the bonus payment amount.

10. The system of claim 9 wherein the bonus determination device is configured to determine a first bonus payment option by:
determining an annual return of the investment portfolio (“R_ann”);
determining an expected return on the investment portfolio (“R_exp”);
comparing the annual return (“R_ann”) to the expected return (“R_exp”);
setting the amount of the first bonus payment option to zero if the annual return (“R_ann”) is not greater than the expected return (“R_exp”); and,
setting the amount of the first bonus payment option to the annual current real amount of the paycheck times the difference between the annual return (“R_ann”) and the expected return (“R_exp”), if the annual return (“R_ann”) is greater than the expected return (“R_exp”).

11. The system of claim 10 wherein the bonus determination device is configured to set the amount of the expected return (“R_exp”) at the expected return rate used by the financial services system to determine the amount of the annual current amount of the paycheck.

12. The system of claim 10 wherein the bonus determination device is configured to determine a second bonus payment option by:
computing a drawdown amount (“Tot_Var”) based on a percentage multiplied by the balance of the savings account on a predetermined date;
wherein the percentage is determined from an upward-sloping glide path that is the inverse of the average of the expected remaining life and the 99.9 percentile of remaining life;
setting the second bonus amount option to the difference between the drawdown amount (Tot_Var) and the annual current real amount of the paycheck, if the amount is greater than zero; otherwise setting the second bonus amount option to zero.

13. The system of claim 10 wherein the bonus determination device configured to determine a second bonus payment option by:
determining a new current real amount of the paycheck based on present circumstances (Tot_New);
comparing the annual total of the new current real amount of the paycheck to the annual total of the current real amount;
if the annual total of the new current real amount of the paycheck is greater than the current adjusted real current real amount, then setting the second bonus amount option to the difference between the new current real amount of the paycheck and the real amount; otherwise setting the second bonus amount option to zero.

14. The system of claim 9 wherein the system is configured to compare the bonus payment amount to a minimum bonus amount and if the bonus payment amount is less than the minimum bonus amount, the system revises the bonus payment amount by setting it at the minimum bonus amount before sending information about the bonus payment amount to the user.

15. The system of claim 9 wherein the system is configured to compare the bonus payment amount to a maximum bonus amount and if the bonus payment amount is greater than the maximum bonus amount, the system revises the bonus payment amount to set it at the maximum bonus amount before sending information about the bonus payment amount to the user.

16. The system of claim 9 wherein the system is configured to provide information to a user device, in a format viewable by a user interface on the user device, about the bonus payment amount.

17. The system of claim 16 wherein the information about the bonus payment amount includes one or more of: the bonus payment amount, a bonus payment date, a bonus payment minimum and a bonus payment maximum.

18. The system of claim 16, wherein the system is configured to automatically generate and send an alert to a user system for display on the user system interface information about the amount of the bonus payment, and information about how and when the bonus payment was made.

19. The system of claim 16, wherein the system is configured to automatically generate and send an alert to a user system for display on the user system interface to display the amount of the bonus payment, and information about how and when the bonus payment will be made.
